(19) United States
(12) Patent Application Publication
(10) Pub. No.: US 2005/0012707 A1
(43) Pub. Date: Jan. 20, 2005

(54) Electrophoretic display and a method of driving said display

(76) Inventor: Hong-Da Liu, Chupei City (TW)

Correspondence Address: Troxell Law Office PLLC, Suite 1404, 5205 Leesburg Pike, Falls Church, VA, 22041, US

(21) Appl. No.: 10/618,663

(22) Filed: Jul. 15, 2003

(51) Int. Cl. G09G 3/34

(52) U.S. Cl. 345/107

(57) ABSTRACT

An electrophoretic display (EPD) has two opposite substrates with electrodes, a fluid and multiple colored charged particles in the fluid. The substrates are defined reflective areas and transmissive areas and has a front face and a rear face. When a positive or negative electric potential is applied to the electrodes on the opposite substrates, the colored charged particles are collected to the reflective areas or the transmissive areas. Therefore, a front light radiated to the first substrate is reflected and a backlight radiated to the second substrate can be controlled to pass through the two opposite substrates. Thus, the EPD in accordance with the present invention can become the reflective or direct-viewing display or both of the reflective and direct-viewing display.

### BACKGROUND OF THE INVENTION

1. Field of the Invention

The present invention relates to an electrophoretic display and a method of driving said display, and more specifically to a method of selectively driving an electrophoretic display in a reflective mode or a direct-viewing display mode.

2. Description of Related Art

E-books have been developed recently, and many people prefer e-books to traditional books. An e-book uses a plane display screen to display digitally generated text so a person can read the e-book. The e-book has lots of advantages over conventional books, but the e-book has not been universally accepted. One reason the e-book has not been universally accepted is power-consumption. The plane display screen needs power to display text. When the power is turned off, the text disappears from the screen. Furthermore, a person 17 must learn how to use the e-book. A method of conserving power while 18 extending the persistence of the text on the screen is needed. The power-consumption problem has been solved, and most people already know how to read an e-book, PDA, etc. The power-consumption problem was solved with the development of e-paper. E-paper is a reflective electrophoretic display material.

A company named E Ink developed a specific display material for the reflective electrophoretic display with embedded electronic ink. The electronic ink's principal components are millions of tiny microcapsules, about the diameter of a human hair. With reference to FIG. 19A, each microcapsule (70) comprises multiple positively charged white particles (71) and multiple negatively charged black particles (72) suspended in a clear fluid (73). The microcapsule (70) has a top (not numbered) and a bottom (not numbered). When a voltage is applied to a microcapsule (70) with a negative potential applied to the top of the microcapsule (70) and a positive potential applied to the bottom of the microcapsule (70), the positively charged white particles (71) move to the top of the microcapsule (70), and the negatively charged black particles (72) move to the bottom of the microcapsule (70). The positively charged white particles (71) at the top are visible to a person and block the negatively charged black particles (72). That is, the top of the microcapsule (70) appears white, and the negatively charged black particles (72) are hidden. With reference to FIG. 19B, reversing the polarity of the voltage applied to the microcapsule (70) causes the negatively charged black particles (72) to move to the top of the microcapsule (70) and the positively charged white particles (71) to move to the bottom and make the microcapsule (70) appear dark. The E Ink claims that their e-paper can be read under direct sunlight and has advantages of high contrast, low power, wide field of vision, etc.

The Xerox company has also proposed a display principle similar to E Ink's. With reference to FIG. 20A, multiple rollers (81) are mounted on a single electrode plate (80). Each roller (81) has a black hemisphere (not numbered) and a white hemisphere (not numbered). The black hemisphere has a positive electric charge (+), and the white hemisphere has a negative electric charge (−). When a negative electric potential is applied to the electrode plate (81), the black hemispheres of the rollers (81) face the electrode plate (80). On the other hand, when a positive electric potential is applied to the electrode plate (80), the white hemispheres of the rollers (81) face the electrode plate (80), as shown in FIG. 20B.

With reference to FIG. 21, the IBM company has developed an electrophoretic display also composed of two electrode plates (91, 92), a colored fluid (90) between the two electrode plates (91, 92) and multiple colored charged particles (93) suspended in the colored fluid (90). The operation of the electrophoretic display is similar to the forgoing descriptions and is not further described.

The examples of electrophoretic displays described have the following common features.

1. All the displays are reflective and display text by reflecting light in the environment.

2. Low power.

3. High contrast.

4. Clear image.

The forgoing features of e-paper are advantages, but the e-paper display cannot display clear text or images when the reflective display is used in an environment with weak light.

The present invention provides an electrophoretic display that has reflective or direct-viewing display mode to mitigate or obviate the aforementioned problems of the conventional methods.

### SUMMARY OF THE INVENTION

An objective of the present invention is to provide an electrophoretic display that can selectively be a reflective display, a direct-viewing display or a combination reflective and direct-viewing display.

Other objectives, advantages and novel features of the invention will become more apparent from the following detailed description when taken in conjunction with the accompanying drawings.

### BRIEF DESCRIPTION OF THE DRAWINGS

FIG. 1 is a side plan view in partial section of a first embodiment of an electrophoretic display pixel in accordance with the present invention;

FIG. 2 is a top plan view of a first embodiment of transparent electrodes of the electrophoretic display in accordance with the present invention;

FIG. 3 is a top plan view of a second embodiment of the transparent electrodes of the electrophoretic display in accordance with the present invention;

FIG. 4 is a top plan view of a third embodiment of the transparent electrodes of the electrophoretic display in accordance with the present invention;

FIG. 5 is a side plan view of a first embodiment of a colored particle for the electrophoretic display in accordance with the present invention;

FIG. 6 is a side plan view of a second embodiment of the colored particle for the electrophoretic display in accordance with the present invention;

FIG. 7 is an operational side plan view in partial section of the electrophoretic display in FIG. 1 displaying a single dark color;

FIG. 8 is an operational side plan view in partial section of the electrophoretic display in FIG. 1 displaying a single light color;

FIG. 9 is an operational side plan view in partial section of the electrophoretic display in FIG. 1 displaying light and dark colors;

FIG. 10 is a side plan view in partial section of the electrophoretic display in FIG. 1 with a backlit module in accordance with the present invention;

FIG. 11 is a side plan view in partial section in partial section of a second embodiment of the electrophoretic display in accordance with the present invention;

FIG. 12 is a side plan view in partial section of a third embodiment of the electrophoretic display in accordance with the present invention;

FIG. 13 is a top plan view of a fourth embodiment of the transparent electrodes with a reflective layer in accordance with the present invention;

FIG. 14 is a top plan view of a fifth embodiment of the transparent electrodes with a reflective layer in accordance with the present invention;

FIG. 15 is a top plan view of a sixth embodiment of the transparent electrodes with a reflective layer in accordance with the present invention;

FIG. 16 is a top plan view of a seventh embodiment of the transparent electrodes with a reflective layer in accordance with the present invention;

FIG. 17 is a top plan view of a eighth embodiment of the transparent electrodes with a reflective layer in accordance with the present invention;

FIG. 18A is a cross sectional side plan view of the reflective layer of the electrophoretic display in accordance with the present invention;

FIG. 18B is a side plan view of a fifth embodiment of the transparent electrodes with a reflective layer in accordance with the present invention;

FIG. 18C is a top plan view of a sixth embodiment of the transparent electrodes with the reflective layer in accordance with the present invention;

FIG. 18D is a top plan view of a seventh embodiment of the transparent electrodes with the reflective layer in accordance with the present invention;

FIG. 19A is a side plan views of a first conventional electrophoretic display in accordance with the prior art;

FIG. 19B is an operational view of the first conventional electrophoretic display of FIG. 19A; and

FIG. 20A is a side plan view of a second conventional electrophoretic display in accordance with the prior art;

FIG. 20B is an operational view of the second conventional electrophoretic display of FIG. 20A; and

FIG. 21 is a side plan view of a third conventional electrophoretic display in accordance with the prior art.

### DETAILED DESCRIPTION OF THE PREFERRED EMBODIMENT

An electrophoretic display (EPD) in accordance with the present invention has a reflective and direct-viewing display mode or a direct-viewing display mode. The EPD has multiple positively and/or negatively charged colored particles, two substrates each having multiple electrodes, wherein reflective and transmissive areas could be all defined on one of the two substrates or respectively on the two substrates. When applying opposite polarity of the voltage to at least two electrodes on the substrates, the charged colored particles are moved to the reflective areas or transmissive areas. That is, the charged color particles on the reflective areas or transmissive areas can be controlled whether the front light is reflected by the reflective area or not, or whether the backlight passes through the EPD or not. Therefore, by controlling the applied polarity of voltage, the EPD can be operated in a reflective display mode if the surrounding light is sufficient, or in a direct-viewing display mode when the surrounding is dim.

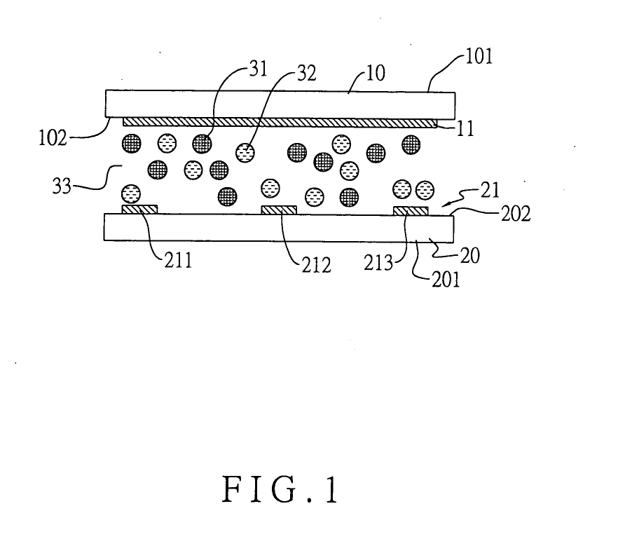

With reference to FIG. 1, each pixel of a first embodiment of the EPD in accordance with the present invention includes a first substrate (10), a second substrate (20), colored charged particles (31,32) and fluid (33). The fluid (33) between the first and second substrates (10, 20) can be transparent or colored. The colored charged particles has dark and white colored charged particles (31, 32) that are suspended in the fluid (33).

The first substrate (10) can be made of a transparent material such as glass, plastic or stainless steel etc. In this preferred embodiment, the first substrate (10) has an outer face (101) and an inner face (102). The outer face (101) to which the front light from a front light module (not shown) passes through is a front face of the EDP for displaying images or text etc. The front light module can be mounted on the front face. A first transparent electrode (11) is printed on the inner face (102) and has at least one first transparent electrode layer (11). The first transparent electrode layer (11) can be defined as the reflective area by collecting enough dark or white colored particles (31, 32).

The second substrate (20) can be made of a transparent or opaque material such as glass, plastic and stainless steel etc. In this preferred embodiment, the second substrate (20) is transparent and parallel with the first substrate (10). The second substrate (20) has an inner face (202) and an outer face (201) defined as a rear face of the EDP. The inner face (202) is faced to the inner face (102) of the first substrate (10). The second transparent electrode (21) has at least two second transparent electrode layers (211, 212, 213). In this preferred embodiment, three second transparent electrode layers (211, 212, 213) are printed on inner face (202) of one pixel of the second substrate (20) and two transmissive areas each is defined between the two second transparent electrode layers (211, 212, 213).

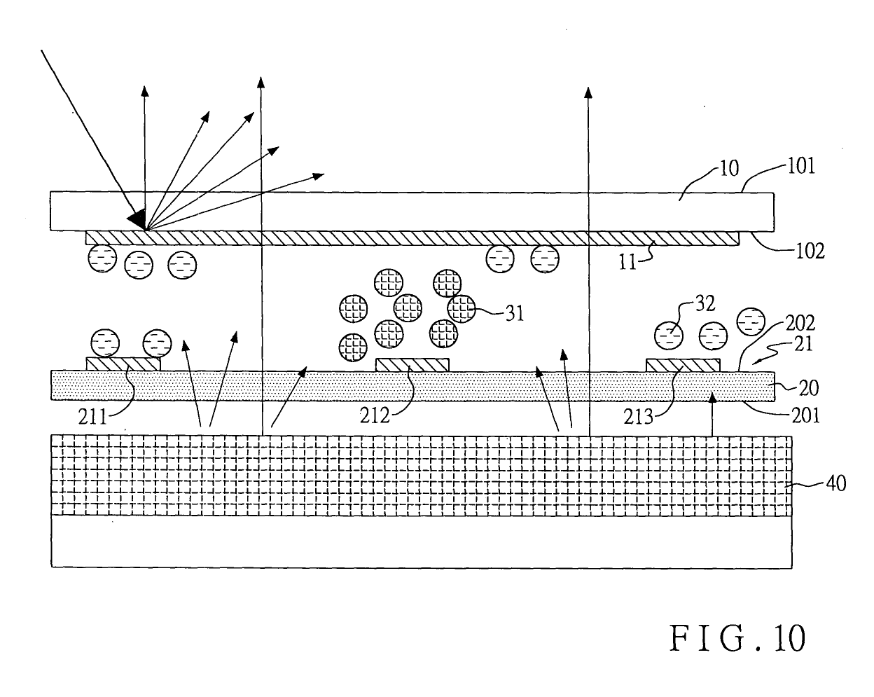

To increase brightness of the EDP in the direct-viewing display mode, with further reference to FIG. 10, a backlit module (40) is adapted to mount to the rear face (201) of the EPD. The backlight radiated from the backlit module (40) can pass through the transmissive areas to the front face (101). The backlit module (40) can be an EL (electro luminescent), PLED (polymeric light emitting diode) or OLED (organic light emitting diode).

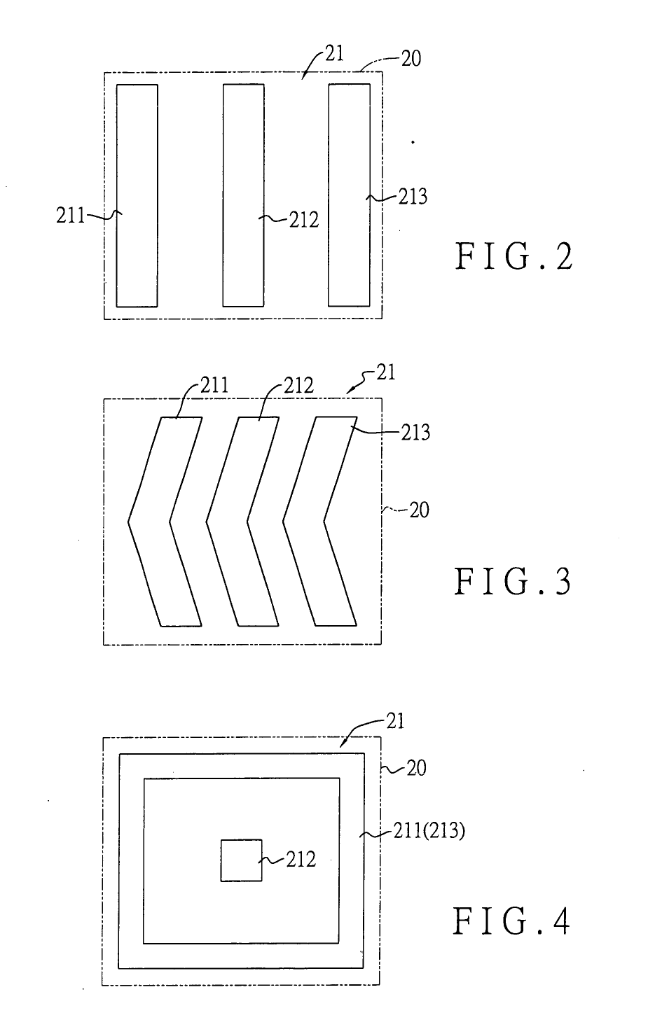

With reference to FIGS. 2 and 3, three second electrode layers (211, 212, 213) of the first embodiment of the EDP are parallel with each other and each second electrode layer (211, 212, 213) can be formed as a long narrow strip shape or a substantially < shape. With reference to FIG. 4, one pixel of the second substrate (20) has two second electrode layers (211, 212), one is a rectangular frame and the other is a squire shape in the rectangular frame. These examples are only one part of useful shapes for the second electrode layers.

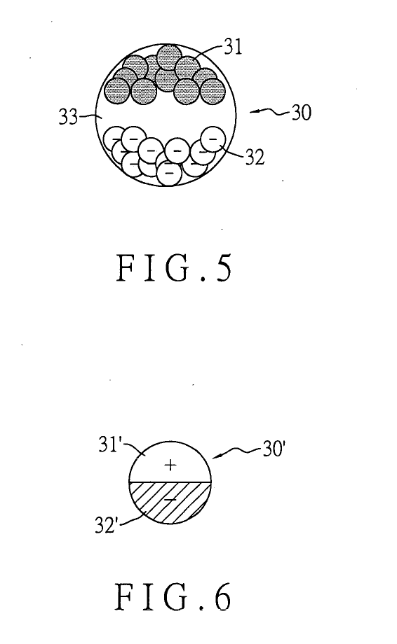

The dark and white colored charged particles (31, 32) filled between the first and second substrates (10, 20) respectively have positive or negative charge. In the first preferred embodiment of FIG. 1, the EPD has positively charged black particles (31) and negatively charged white particles (32) between the first and second substrates (10, 20). With reference to FIG. 5, the EPD also can use microcapsules (30). Each microcapsule (30) has a transparent capsule (not numbered) in which clear fluid (33) and colored charged particles (31, 32) are contained. With reference to FIG. 6, the EPD uses rollers (30′). Each roller (30′) is composed of a white hemisphere (31′) and a dark hemisphere (32′). The whit hemisphere (31′) possess a positive electric charge (+), and the black hemisphere (32′) possess a negative electric charge (−).

The forgoing description discloses a basic structure of the EPD. The following means for driving the EDP is used to the forgoing EPD to make the EPD to have a reflective and/or a direct viewing display mode or a direct viewing display mode.

(1) Reflective Display Mode of the EPD:

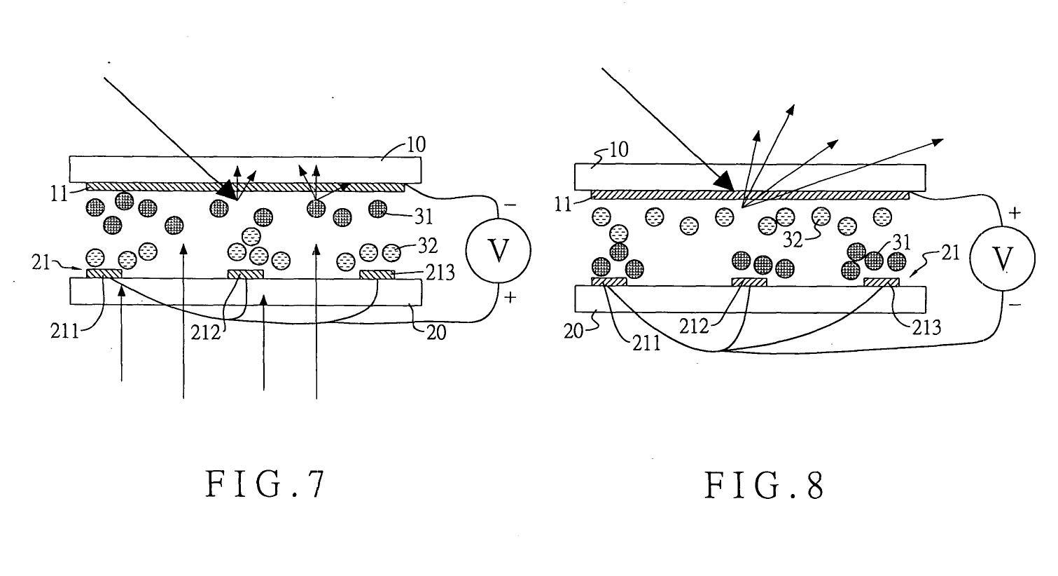

With reference to FIG. 7, a negative potential voltage and a positive potential voltage are respectively applied to the first and second electrode layers (11, 211, 212, 213) of the EDP. The positively charged black particles (31) are moved and collected to the first electrode layer (11) and the negatively charged white particles (32) are moved and collected to the second electrode layers (211, 212, 213). Therefore, the reflective area is established on the first substrate (10) by collecting these positively charged black particles. That is, the front face displays dark spot because the front light is not reflected by the black charged particles and the backlight is blocked not to pass through the first substrate (10).

With reference to FIG. 8, reserving the potentials of voltages applied to the first and second electrode layers (11, 121, 122, 123) causes the negatively charged white particles (32) to be moved and collected to the first electrode layer (11) and the positively charged black particles (32) to be moved and collected to the second electrode layers (11, 211, 212, 213). The front face displays light spot because the front light is reflected by the negatively charged white particles that is collected to the first electrode layer (11).

(2) Direct Viewing Display Mode of the EPD:

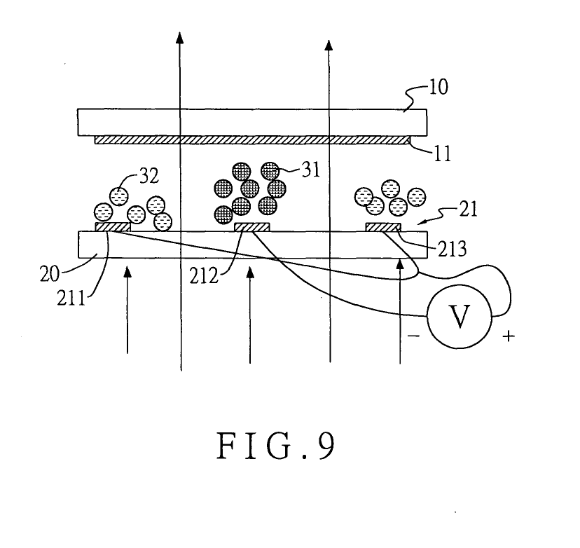

With reference to FIG. 9, the means for driving the EDP is accomplished by applying a negative and a positive potential voltages to the second electrode layers (211, 212, 213). That is, the positive potential voltage is applied to the two second electrode layers (211, 213) and the negative potential voltage is applied to the one second electrode layer (212). All the white and black particles (31,32) are connected to the three seconds electrode layers (211, 212, 213). Each transmissive area is defined between two of the second electrode layers (211 to 213) so the backlight can pass through the second and first substrates. The EPD display light spots.

With reference to FIG. 1, a second embodiment of the EPD in accordance with the present invention shows two pixels that are separated by a dotted line (L).

The first substrate (10) has one first electrode layer (11) and the second substrate (20) has one second electrode layer (21) that is narrower than the first electrode layer (11). One reflective and transmissive area (210) is formed on the second substrate (20) and between the two second electrode layers (21). A third electrode layer (22) is formed on the reflective and transmissive area (210) and is composed of a reflective electrode with high reflectance and a transparent electrode such as ITO or IZO etc. The transparent electrode is defined as the transmissive area (220). The colored charged particles (31) are black charged particles.

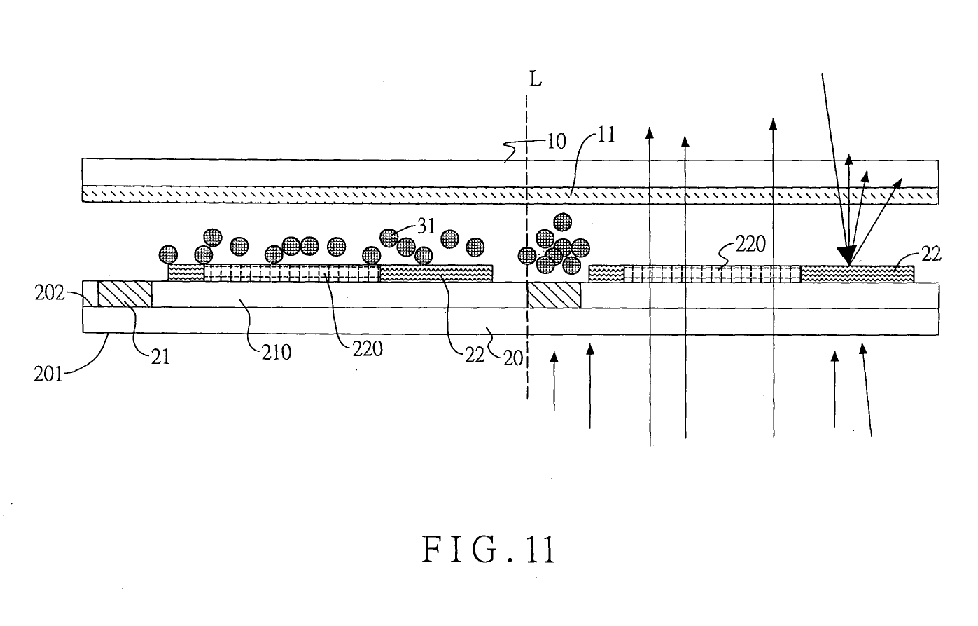

In the FIG. 11, the left side pixel displays dark spot and the right side pixel displays light spot. When a negative or positive electric potential is applied to the third electrode (22), the black charged particles (31) are collected to the third electrode (22) to cover the reflective and transmissive area (210). The backlight radiated to the rear face (201) of the second substrate (20) cannot pass through the third electrode (22) and the front light is not reflected by the black charged particles (30). Therefore, the left pixel of the EPD displays dark spot.

Further, when a negative or positive electric potential is applied to the second electrode (21), the black charged particles (31) are collected to the second electrode (21) and cannot cover the reflective and transmissive area (210). The backlight can pass through the third electrode (22) and the first substrate (10) and the front light is reflected by the reflective electrode (not numbered) of the third electrode (22), so the right side pixel displays the light spot.

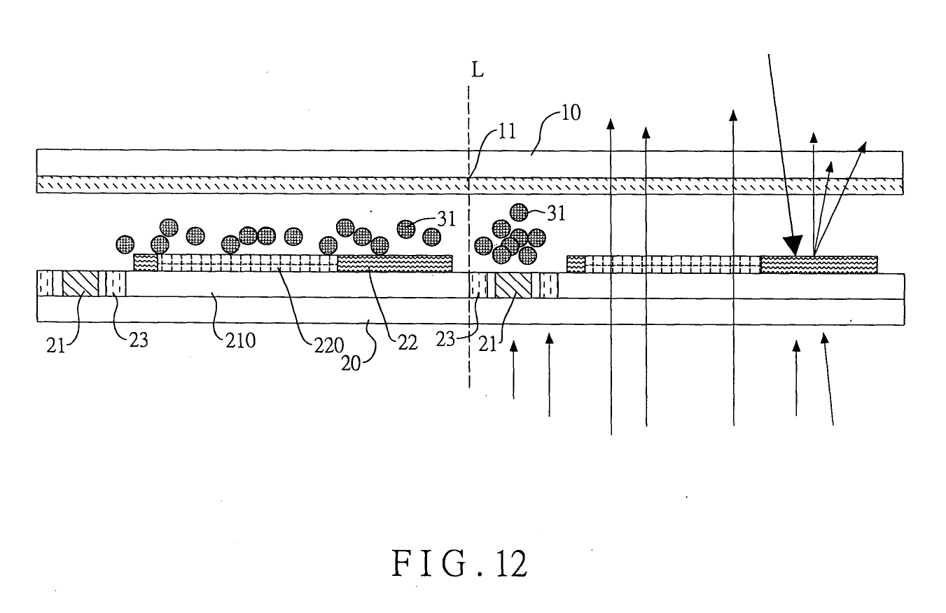

With reference to FIG. 12, a third embodiment of the EPD in accordance with the present invention is similar to the second embodiment. The third embodiment also shows two pixels that are separated by the dotted line (L). The third embodiment further comprises a forth electrode 23 is formed on the second substrate (20) and surrounded the second electrode layer (21). The forth electrode (23) can enhance the black charged particles (31) to move efficiently.

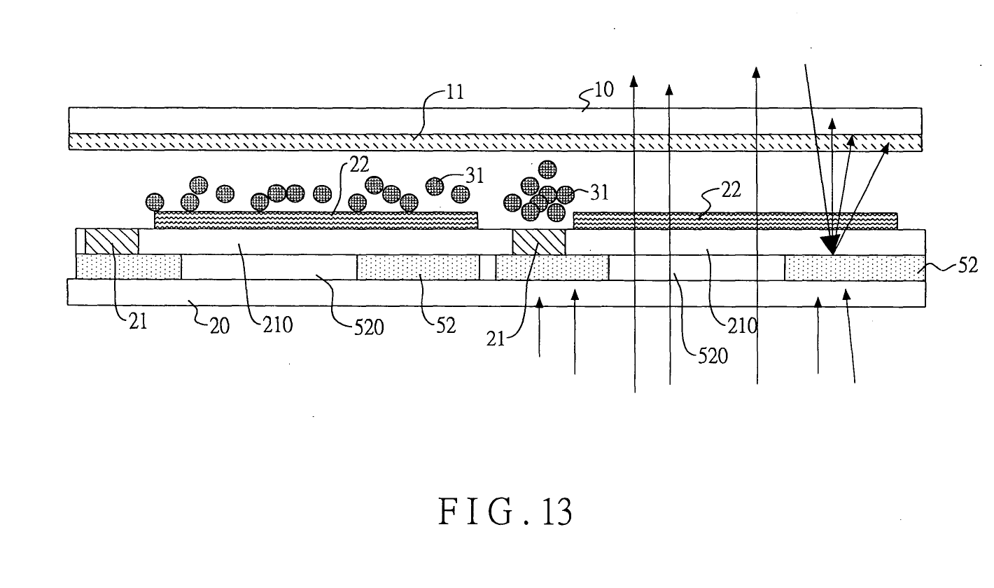

With reference to FIG. 13, a forth embodiment of the EPD in accordance with the present invention is similar to the third embodiment. In the forth embodiment, the third electrode is made of the transparent electrode and further comprises a reflective layer (52) that is formed between the second electrode layer (21) and the reflective and transmissive area (210) and the second substrate (20). The reflective layer (52) is made of multiple films. The reflective layer (52) has a transmissive area (520) corresponding to the reflective and transmissive area (210). In addition, the reflective layer (52) is also formed between the third electrode (22) and the second electrode layer (21) and the reflective and transmissive area (210).

With reference to the left side pixel of the FIG. 13, when a negative or positive electric potential is applied to the third electrode (22), the black charged particles (31) are collected to the third electrode (22) to cover the reflective and transmissive area (210) and the transmissive area (520) of the reflective layer (52). The backlight cannot pass through the third electrode (22) and the first substrate (10) and the front light is not reflected by the black charged particles (31). Therefore the left side pixel displays dark spot.

When a negative or positive electric potential is applied to the second electrode layer (21), the black charged particles are collected to the second electrode layer (21). The backlight can pass through the transmissive area (520) of the reflective layer (52), the reflective and transmissive area (210) and the first substrate (10). The front light is upward reflected by the reflective layer (52), so the right pixel displays light spot.

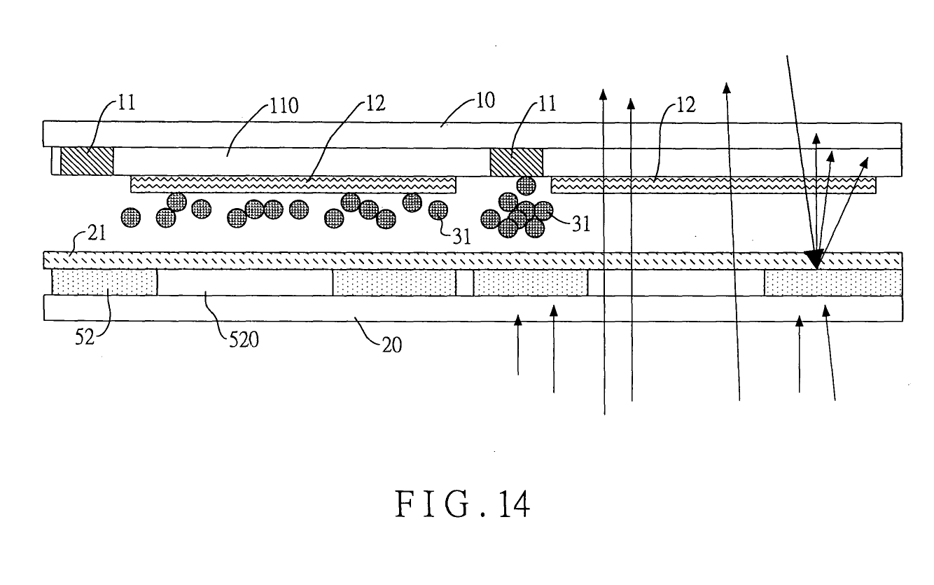

With reference to FIG. 14, a fifth embodiment of the EPD in accordance with the present invention comprises a first substrate (10) with first electrodes (not numbered), a second substrate (20) with a second electrodes (not numbered), black charged particles (31) between the first and second substrates (10, 20), a transmissive area (110) is formed between the two first electrode (11), a third electrode (12) formed on the transmissive area (110) and a reflective layer (52) formed between the second electrode (21) and the second substrate (20).

The first electrode (not numbered) has only one first electrode layer (11) and the second electrode (not numbered) has one second electrode layer (21). The first electrode layer (11) is narrower than the second electrode layer (21).

The driving method is similar to the forth embodiment and is not further described.

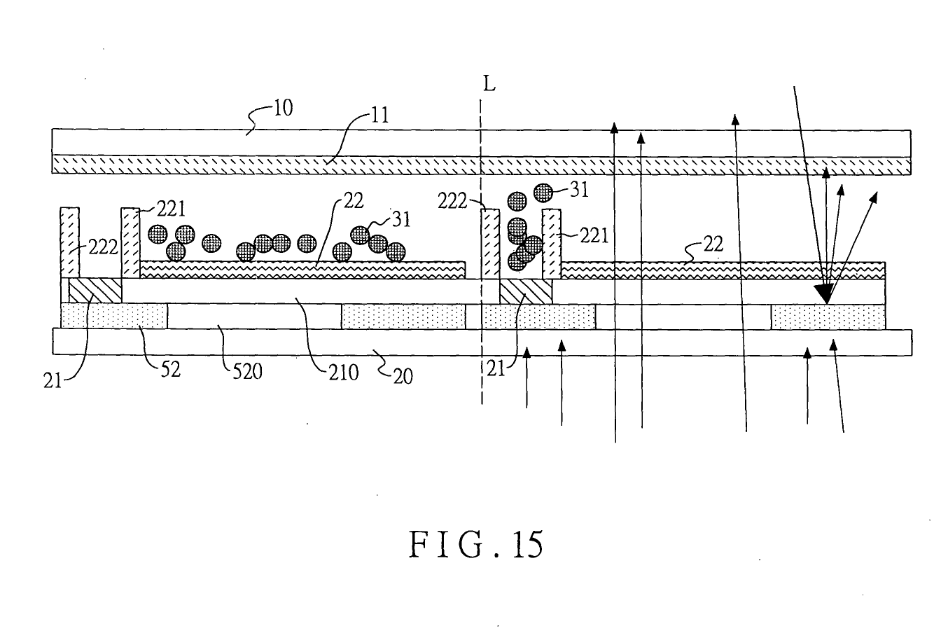

With reference to FIG. 15, a sixth embodiment of the EPD in accordance with the present invention is similar than the fourth embodiment. The sixth embodiment further comprises two opposite walls (221, 222) that are formed two sides of the corresponding second electrode layer (21) and higher than the second electrode layer (21).

When a negative or positive electric potential is applied to the second electrode layer (21), the black charged potentials (31) are collected between the two opposite walls (221,222). The black charged particles (31) can not block portion reflective light or backlight to go to the first substrate (10), so right pixel can displays light spot with more brightness.

The forgoing first to sixth embodiments are disclosed the electrodes are respectively formed on the first and second substrate. However, the electrodes formed either the first substrate or second substrate can make the EPD has reflective and transmissive display mode.

With reference to FIG. 16, a seventh embodiment of the EPD in accordance with the present comprises a first substrate (10), a second substrate (1), black charged particles (31) between the first and second substrates (10, 11), reflective layers (52) formed on the second substrate (20) and electrode (21). In one pixel, the reflective layer (52) has a transmissive area (520). Each electrode (21) formed on the reflective area (52) has three electrode layers (210 to 212) each is thicker than the second electrode layer as disclosed above. One electrode layer (210) is formed on the transmissive area (520) and the other two electrode layers (211, 212) are not formed on the transmissive area (520) but is closer to the periphery of the reflective layer (52). Therefore, the black charged particles (31) are between the two of the electrode layers (210, 211) (210,212).

The FIG. 16 shows a left pixel and a right pixel. The black charged particles (31) are between the two of the electrode layers (210, 211) (210,212) so the transmissive area (520) is covered by the black charged particles (31). The left pixel displays dark spot.

When a negative or positive electric potential is applied to the two electrode layers (211, 212) closed to the periphery of the reflective layer (52), the black charged particles (31) are collected to the two electrode layers (211, 212). The backlight can pass through the transmissive area (520) and the first substrate (10) and the front light is reflected upward by the reflective layer (52). Therefore, the right pixel displays light spot.

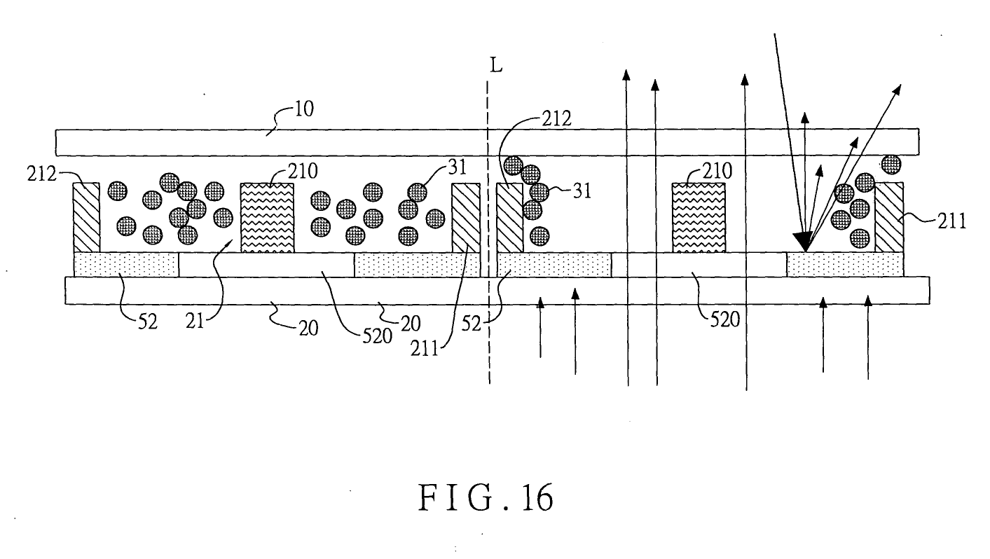

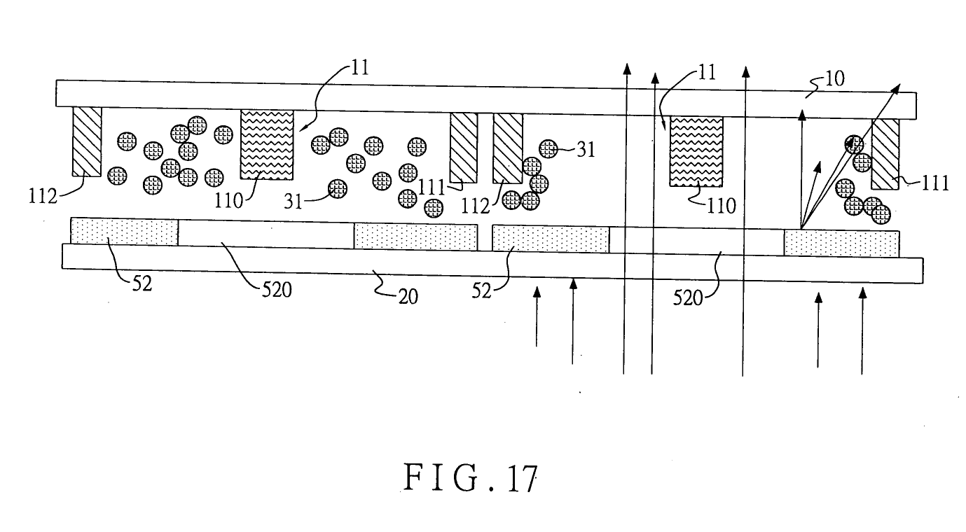

With reference to FIG. 17, a eighth embodiment of the EPD in accordance with the present invention comprises: a first substrate (10), a second substrate (20), black charged particles (31) between the first and second substrates (10, 20), reflective layers (52) formed on the second substrate (20) and electrode (11). In one pixel of the EPD, the reflective layer (52) has a transmissive area (520). Each electrode (11) formed on the first substrate (10) has three electrode layers (110 to 112) each is thicker than the first electrode layer as disclosed above. One electrode layer (110) is aligned with the transmissive area (520) and the other two electrode layers (111, 112) are aligned with the periphery of the reflective layer (52).

The driving method of the eighth embodiment is similar to the seventh embodiment and is not further described.

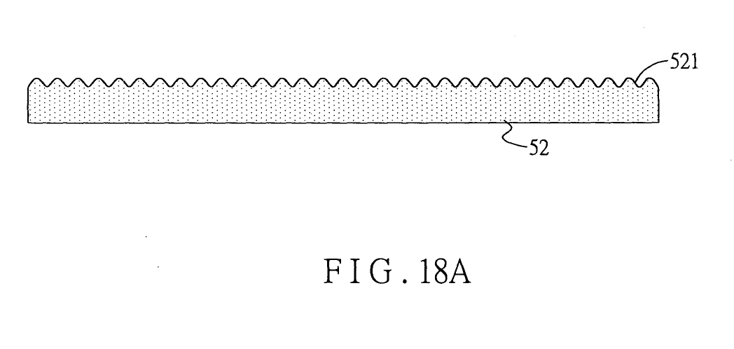

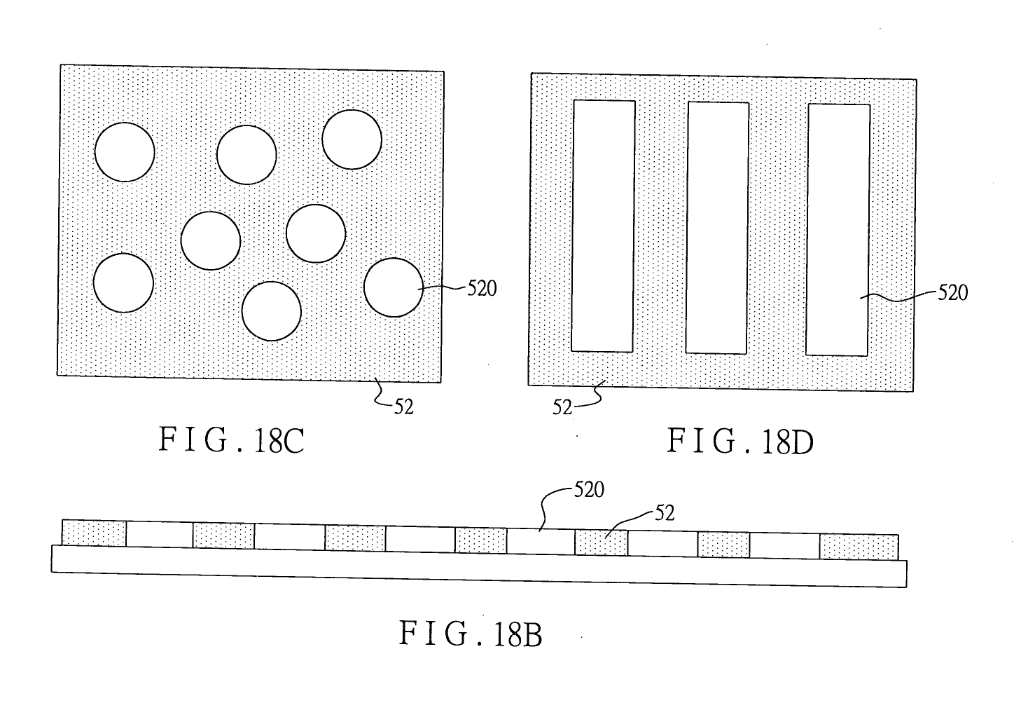

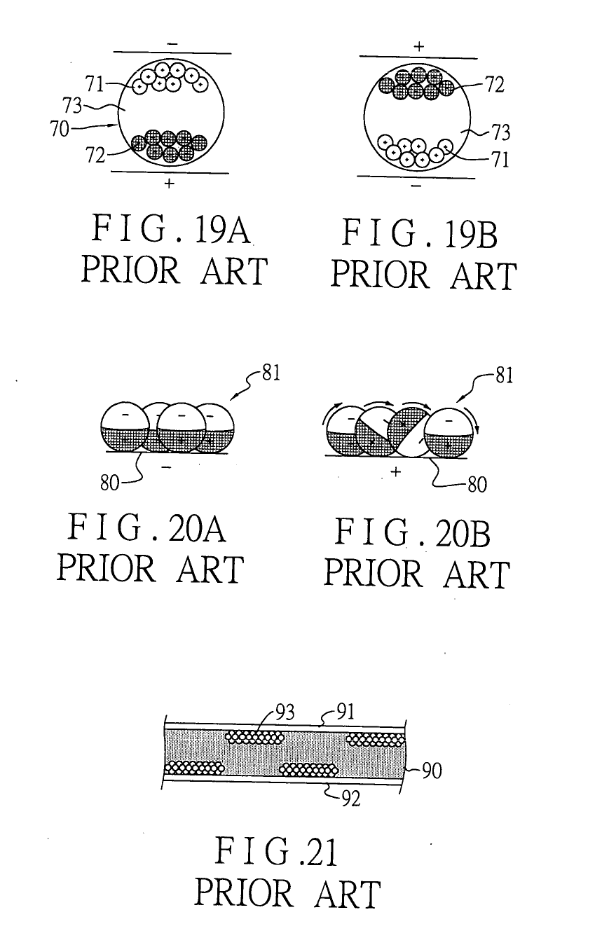

To increase the brightness of the front face (101) the reflective layer (52) has an upper face. With reference to FIG. 118A, the upper face is processed to be diffusive or random wave shaped to provide a scattering capability. Besides, the upper face can be processed to be flat as a mirror. With reference to FIG. 18B, the second electrode layers (211) and the reflective layer (52) are alternately formed on the second substrate (not shown). With reference to FIG. 18C, each second electrode layer (211) is circle formed on the second substrate (not shown) and the reflective layer (51) is formed on the second substrate which is not covered by the second electrode layers (211). With reference to FIG. 18D, the three second electrode layers (211) are paralleled each other on the second substrate and the reflective layer (52) formed on the second substrate.

Based on the forgoing description, the present invention discloses that an EPD having reflective and direct-viewing display modes by means for driving EPD. The means for driving EPD can be used either a static driving circuit or an active circuit. That is, the EPD can become reflective display or a direct-viewing display. When the EPD in sunshine environment, the EPD has enough front light to display so the EDP uses the reflective display mode. On the other hand, when the EPD in light weak environment, the EPD can drive the backlight module to provide a backlight and uses the direct-viewing display mode. Therefore, the present invention can provide high quality of display information or image whether the light is enough or not.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method for driving an electrophoretic display (EPD), wherein the EPD comprises two opposite substrates each has electrodes, fluid between the two substrates, colored charged particles suspended in the fluid and reflective and transmissive areas defined on one of the two substrates or on the two substrates, comprising:
applying positive and negative electric potentials respectively to the electrodes to collect the colored charged particles to the reflective or transmissive areas to control whether front light is reflected by the reflective areas or whether backlight passes through the two substrates.

2. The method as claimed in claim 1, wherein the two opposite substrate are named a first substrate and a second substrates and each substrate has an inner face and outer face, wherein the electrodes formed on the inner face of the first substrate are first electrodes and the electrodes formed on the inner face of the second substrate are second electrodes, comprising:
applying the positive or negative electric potential to the first electrodes to collect the colored charged particles on the first electrodes defined the reflective areas to control whether the front light radiated to the first substrate is reflected by the reflective areas or not.

3. The method as claimed in claim 1, wherein the two opposite substrate are named a first substrate and a second substrates and each substrate has an inner face and outer face, wherein the electrodes formed on the inner face of the first substrate are first electrodes and the electrodes formed on the inner face of the second substrate are second electrodes, comprising:
the transmissive areas defined on the second substrate by the second electrodes, whereby adding the positive or negative electric potential to the second electrodes collects the colored charged particles on the transmissive areas to whether the backlight passes through the transmissive areas.

4. The method as claimed in claim 3, further comprising forming third electrodes that are respectively formed on the corresponding transmissive areas of the second substrate, wherein applying the negative or positive electric potential to the second or third electrodes to control whether the colored charged particles are collected to the second or third electrodes or not.

5. The method as claimed in claim 4, wherein each third electrode is a reflective electrode having a transmissive area that is corresponding to the transmissive area on the second substrate.

6. The method as claimed in claim 4, wherein each third electrode is a transparent electrode as a transmissive area, wherein applying the positive or negative electric potential to the third electrode to control whether the colored charged particles collect to the third electrode or not.

7. The method as claimed in claim 2, further comprising forming third electrodes on the transmissive areas that are defined on the first substrate by the first electrodes, whereby the positive or negative electric potential is applied to the third electrodes to control whether the colored charged particles collect to the third electrodes or not.

8. The method as claimed in claim 3 further comprising adding a reflective layer between the second electrodes and the second substrate.

9. The method as claimed in claim 8, wherein the reflective layer further has an upper face and a transmissive area that is corresponding to the transmissive area on the second substrate, wherein the upper face is processed to be a diffusive or random wave shaped to provide a light scattering capability.

10. The method as claimed in claim 1 wherein the colored charged particles are composed of microcapsules each has a transparent capsule, negatively and positively charged colored particles in the transparent capsule and a clear or colored fluid is in the transparent capsule.

11. The method as claimed in claim 1 wherein the colored charged particles are composed of rollers each has two colored hemispheres that respectively have a positive electric charge and a negative electric charge.

12. An electrophoretic display (EPD), comprising:
two opposite substrates with electrodes;
colored charged particles are between the two opposite substrates; and
reflective and transmissive areas are defined on one of the two opposite substrates or both of them by the electrodes, wherein some of the electrodes are corresponding to the transmissive areas.

13. The EPD as claimed in claim 12, wherein the two opposite substrate are named a first substrate and a second substrates each has an inner face and an outer face, wherein the two inner faces are faced each other and the electrodes are formed on the inner face of the first substrate are first electrodes and the electrodes are formed on the inner face of the second substrate are second electrodes.

14. The EPD as claimed in claim 13, further comprising two opposite walls each is formed on two opposite sides of each second electrode and is higher than the second electrode.

15. The EPD as claimed in claim 12, wherein the transmissive or reflective areas are defined on the opposite substrates and the some electrodes are formed on the corresponding areas.

16. The EPD as claimed in claim 13, further comprising a reflective layer that is formed between the second electrodes and the second substrate and
has an upper face and a transmissive area that is corresponding to the transmitting area on the first substrate, wherein the upper face is processed to a diffusive or random wave shaped to provide a light scattering capability.

17. The EPD as claimed in claim 12, wherein the colored charged particles are composed of microcapsules each has a transparent capsule, negatively and positively charged colored particles in the transparent capsule and a clear or colored fluid is the capsule.

18. The EPD as claimed in claim 12, wherein the colored charged particles are composed of rollers each has two colored hemispheres that respectively have a positive electric charge and a negative electric charge.

19. The EPD as claimed in claim 12, wherein the colored charged particles are single color and have positively charge or negatively charge.

20. The EPD as claimed in claim 13, wherein each first electrode is covered one whole pixel area of the first electrode and each second electrode has at least two second electrode layers.

21. The EPD as claimed in claim 13, wherein each first electrode has at least one first electrode layer and each second electrode is covered one whole pixel area of the second substrate.

22. The EPD as claimed in claim 13, further comprising a backlit module that is mounted on the outer face of the second substrate.

23. The EPD as claimed in claim 13, further comprising a front light module that is mounted on the outer face of the first substrate.

24. The EPD as claimed in claim 13, wherein the first and second substrates are made of the glass, plastic or stainless steel material.

25. The EPD as claimed in claim 12, wherein the some of the electrodes are driven by a static driving circuit.

26. The EPD as claimed in claim 12, wherein the some of the electrodes are driven by an active driving circuit.
